(19) United States
(12) Patent Application Publication
(10) Pub. No.: US 2006/0034998 A1
(43) Pub. Date: Feb. 16, 2006

(54) Sauces comprising dietary fiber gel

(75) Inventors: Triveni P. Shukla, New Berlin, WI (US); Gregory J. Halpern, Vernon Hills, IL (US)

Correspondence Address: Timothy J. Fullin, 1011 Campus Drive, Mundelein, IL, 60060, US

(73) Assignee: Circle Group Holdings, Inc.

(21) Appl. No.: 11/251,639

(22) Filed: Oct. 14, 2005

Related U.S. Application Data
(63) Continuation-in-part of application No. 10/878,913, filed on Jun. 28, 2004.

(51) Int. Cl. A23L 1/40

(52) U.S. Cl. 426/589

(57) ABSTRACT

According to the present invention, fat and caloric content of sauces can be reduced by the replacement of a portion fat content normally found in sauces with an equal amount of dietary fiber. The result is that fat and caloric content of sauces can be manipulated with minimal effect on taste and texture. Furthermore, the sauces can further comprise functional foods that increase health and nutritional benefits of the sauces. The functional foods can be added individually, and in any combination thereof. Hence, in addition to reducing fat and caloric content of sauces by replacing a portion of fat with dietary fiber gel, additional health benefits can be achieved with compositions that include functional foods.

### CROSS-REFERENCE TO RELATED APPLICATIONS

This application is a Continuation-in-Part application of U.S. patent application Ser. No. 10/878,913 filed on Jun. 28, 2004, the entirety of which is incorporated herein.

### STATEMENT REGARDING FEDERALLY SPONSORED RESEARCH/DEVELOPMENT

The present invention does not involve any form of federally sponsored research or development.

### BACKGROUND OF THE INVENTION

The present invention relates to sauces generally, and most notably cheese sauces comprising dietary fiber gel. Recent media attention to the global problem of obesity demonstrates a need for greater availability of foods with low caloric and fat content. This is especially true for foods that typically have high fat and caloric content, such as sauces.

Sauces, especially cheese sauces typically comprise some fat. Other ingredients can vary according to the type of sauce and the recipe followed, but typically, sauces are high in both fat and caloric content.

In recent years, some companies have begun to offer reduced fat sauces. This variety of sauce, however, often fails to retain the desirable taste and texture of sauces comprising higher fat contents.

Accordingly, there is a need for reduced fat and caloric content sauces that have the desirable flavor and texture of high fat and high caloric content sauces.

### BRIEF SUMMARY OF THE INVENTION

A composition of matter for use in producing high-fiber, low-calorie and low-fat sauces is provided. The composition includes dietary fiber gel that replaces fat in sauces. In addition, compositions are provided that include dietary fiber gel and other functional ingredients for nutritionally fortified sauces.

Dietary fiber gels for calorie reduced foods hold the key to meeting this need. Dietary fiber gels for calorie reduced foods are fully described in U.S. Pat. No. 5,766,662 (the '662 patent), which is herein incorporated by reference in its entirety. These dietary fiber gels comprise insoluble dietary fibers consisting of morphologically disintegrated cellular structures, and are characterized by their ability to retain large amounts of water. These amorphous insoluble cellulosic fiber gels are produced by shearing agricultural by-products, such as seed brans, hulls, and so forth, under alkaline conditions. Amorphous insoluble cellulosic fiber gels in a hydrated form can exist as gel, and in the dehydrated form as flakes and powders. Additionally, their high viscosity at low solid levels characterizes these dietary fiber gels. Other insoluble fibers derived from cereals, grains and legumes consist of morphologically in tact cellular structures, and thus impart a gritty texture to the foods in which they are contained. The amorphous insoluble cellulosic fiber gels disclosed in the '662 patent (also herein referred to as dietary fiber gels), however, are amorphous in nature and consist of morphologically disintegrated cellular structures; they thus impart a smoother texture than other insoluble fiber formulations. The physically smooth morphology is readily revealed under electron microscopic magnification of amorphous insoluble cellulosic fiber gel. The smooth morphology is also demonstrated by approximately 60 percent to 90 percent reduction in birefringence when compared to microcrystalline dietary fiber products. The smooth morphology reflects the amorphous nature of the insoluble compounds that constitute amorphous insoluble cellulosic fiber gel.

According to the present invention, fat and caloric content can be reduced by the replacement of the fat normally found in sauces with dietary fiber gel and water. This replacement of fat does not adversely affect either the taste or texture of the sauces. In fact, the added dietary fiber gel helps to increase the moisture content of the sauces while simultaneously lowering the fat content. The result is that fat and caloric content of sauces can be manipulated with minimal effect on taste and texture, and as stated above, additional health benefits can be achieved through consumption of sauces comprising dietary fiber gel and water when functional foods are included in the formulations.

Further objects, advantages and features of the present invention will present themselves in the following detailed description.

### DETAILED DESCRIPTION OF THE PREFERRED EMBODIMENT

The following description provides for the use of dietary fiber gels for fat and calorie reduced sauces. When substituted for fat containing compounds, dietary fiber gels reduce the fat and calorie content of food products. Dietary fiber gels are fully described in U.S. Pat. No. 5,766,662 (the '662 patent), which is incorporated by reference herein. These dietary fiber gels comprise insoluble dietary fibers consisting of morphologically disintegrated cellular structures, and are characterized by their ability to retain large amounts of water. The dietary fiber gels are produced by shearing agricultural by-products, such as seed brans, hulls, and so forth, under alkaline conditions. Dietary fiber gels in a hydrated form can exist as a gel, and in the dehydrated form as flakes and powders. Dietary fiber gels are characterized by high hydration capacity when reconstituted with water. Additionally, these dietary fiber gels are characterized by their high viscosity at low solid levels. Other insoluble fibers derived from cereals, grains and legumes derived by conventional dry milling consist of morphologically in tact cellular structures, and thus impart a gritty texture to the foods in which they are contained. The dietary fiber gels disclosed in the '662 patent, however, consist of morphologically disintegrated cellular structures and thus impart a smoother texture than other insoluble fiber formulations. A physically smooth morphology is readily revealed under electron microscopic magnification of dietary fiber gel. The smooth morphology reflects the amorphous nature of the non-particulate insoluble compounds that constitute dietary fiber gel.

According to the present invention, fat and caloric content can be reduced by the replacement of the fat-containing ingredients normally found in sauces with dietary fiber gel, such as shortening compositions comprising dietary fiber gel. Substituting dietary fiber gel for fat does not adversely affect either the taste or texture of the sauces.

Alternatively, the sauces can be provided in the form of sauce mixes with the intention that a consumer can mix them at a convenient, post-purchase time, and sauce mixes are considered to be within the scope of this invention. As such, for purposes of this document, the term “sauces” is defined to include sauce mixes.

Sauces can be of a number of different varieties, including but not limited to cheese sauces, creamy type sauces, alfredo sauces, and gravies. The different categories of sauces available to consumers can be formulated such that the sauces have reduced fat and calories. Sauces can be formulated such that the sauces comprise 0.5 percent to 8.0 percent dietary fiber gel solids by replacing an appropriate amount, that is, prorated to deliver this range of dietary fiber gel solids, of fat, such as included in oil and liquid shortening. The result is that fat and caloric content of sauces can be manipulated with minimal effect on taste and texture, and as stated above, additional health benefits can be achieved through consumption of sauces comprising dietary fiber gel when functional foods are included in the formulations.

Functional ingredients can be added to the composition of sauces to increase health and nutritional benefits of this food. Most notably functional foods such as high omega three and omega six oils and pure omega three and omega six fatty acids, medium chain triglyceride, beta carotene, calcium stearate, vitamin E, bioflavonoids, fagopyritrol, polyphenolic antioxidants of vegetable origin, lycopene, luteine and soluble fiber, for example Beta-Glucan derived from yeast, and other soluble fibers derived from grain, flax seed, and other vegetable and fruit fiber sources can be added to sauces.

The following ranges of the functional foods in sauces are given by way of example, but other functional foods, notably fat soluble functional foods, can be added as well. High omega three oils and omega six oils, for example flax seed oil, can be added in concentrations of 1 percent to 50 percent of the composition by weight. Pure omega three fatty acids and omega six fatty acids can be added in concentrations ranging from 1 percent to 30 percent of the composition by weight. If both pure omega three or six fatty acids and high omega three oils are used, their respective concentrations can be prorated to give an appropriate end concentration of high omega three fatty acids. Medium chain triglyceride can be added in concentrations ranging from 1 percent to 30 percent of the composition by weight. Fagopyritrol or foods containing fagopyritrol can be added in concentrations of 0.25 percent to 20 percent of the composition by weight. Polyphenolic antioxidants of vegetable origin, for example lycopene, beta carotene, luteine, and bioflavonoids can be added in concentrations ranging from 0.25 percent to 20 percent of the composition by weight. Soluble fiber, for example beta Glucan, can be added in concentrations ranging from 5 percent to 15 percent of the composition by weight. Any functional foods added to the composition can be added in such concentrations to deliver up to 100 percent, preferably 25 percent to 100 percent, of prevailing recommended daily intake recommendations by the FDA (Food and Drug Administration of the United States), European Commission, and reported by the FAO (Food and Agricultural Organization of the United Nations) in the Codex Alimentarius, or other international authorities.

Although the present invention is illustrated by the example of sauces, such as cheese sauces, creamy type sauces, alfredo sauces, gravies, and so forth, and sauce mixes, the present invention applies to foods and food formulations that include fat containing ingredients such as oils, greases, and lards that are derived from vegetable, animal, or synthetically produced that are used in the mixing, baking, reheating or other processing as necessary to produce edible foods.

An advantage of the present invention is the ability to provide a unique composition of matter embodied by low-calorie and low-fat sauces. The fat and caloric content are advantageously reduced by the replacement of the fat normally found in sauces with compositions comprising dietary fiber gel. Food compositions that reduce caloric and fat content answer an unmet need in the food industry to provide the consuming public with a healthier, higher fiber alternative to traditional types of sauces that typically are inherently fattening. Another advantage is the providing sauces that have been fortified with insoluble fiber and other functional foods. Yet another advantage is that the fat replacement with dietary fiber gel does not adversely affect either the taste or texture of sauces. Finally, the fat and caloric content of sauces can be advantageously manipulated with minimal adverse effect on taste and texture, and additional health benefits can be achieved through composition of sauces comprising dietary fiber gel when functional foods are included in the formulations.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

### EXAMPLE 1

### Cheese Sauce Comprising Dietary Fiber Gel

TABLE 1

| | Weight % | Weight % | |
|---|---|---|---|
| Ingredient | Without | With | Remarks |
| Velveeta, 21% Fat | 50.50 | 35.00 | Can be replaced |
| | | | with cheddar |
| | | | cheese |
| Butter, 82% Fat | 7.00 | 4.00 | |
| Flour | 6.00 | — | |
| Dietary Fiber Gel | | 2.00 | |
| Skim Milk | 32.50 | 50.50 | |
| Roasted minced garlic | 1.00 | 1.00 | |
| Chopped Chive | 2.00 | 2.00 | |
| Horseradish | 0.50 | 0.50 | Can be replaced |
| | | | with mustard |
| Salt | 0.50 | 0.50 | |
| TOTAL | 100.00 | 100.00 | |
| Percent Fat | 16.35 | 10.63 | |

PROCEDURE: Add skim milk and Dietary Fiber Gel powder to a Warring Blender. Make Dietary Fiber Gel mixture by high speed mixing for three minutes. Now add melted butter, small cubes of Velveeta® cheese, and the rest of the ingredient. Mix 1 minute at low speed.

Two formulations of Cheese Sauce are presented in Table 1. One sauce formulation, labeled here as “Without”, represents a typical formulation for Cheese Sauce. A Cheese Sauce formulation, labeled here as “With”, demonstrates a variation on the “Without” formulation and comprises Dietary Fiber Gel. The formulation comprising Dietary Fiber Gel exhibits a 55.3% reduction in fat compared to its counterpart formulation and comprises 2.00% (by weight) amorphous insoluble cellulosic fiber gel solids. Thus, in addition to eliminating over 55% of the fat from a representative typical Cheese Sauce formulation, healthy dietary fiber has been added, making the “With” formulation a vehicle of delivery for insoluble dietary fiber.

I claim:

1. Sauce, the sauce having a formulation, the sauce comprising dietary fiber gel, wherein dietary fiber gel is added in a prorated amount such that solids contained within the dietary fiber gel represent 0.5 percent to 8.0 percent by weight of the overall sauce formulation, and dietary fiber gel replaces an amount of fat used in an otherwise identical recipe of sauce that uses no dietary fiber gel.

2. Sauce of claim 1, wherein the sauce is a cheese sauce.

3. Sauce of claim 1, wherein the sauce is a creamy type sauce.

4. Sauce of claim 1, wherein the sauce is an alfredo sauce.

5. Sauce of claim 1, wherein the sauce is a gravy.

6. Sauce of claim 1, wherein the sauce is made from a sauce mix.

7. Sauce mix of claim 6, wherein the mix, when reconstituted, results in a cheese sauce.

8. Sauce mix of claim 6, wherein the mix, when reconstituted, results in a creamy type sauce.

9. Sauce mix of claim 6, wherein the mix, when reconstituted, results in an alfredo sauce.

10. Sauce mix of claim 6, wherein the mix, when reconstituted, results in a gravy.

11. Sauce of claim 1, further comprising at least one functional food and combinations thereof selected from a group consisting of
high omega three oil, wherein high omega three oil represents 1 percent to 50 percent of the sauce by weight,
pure omega three fatty acid, wherein pure omega three fatty acid represents 1 percent to 30 percent of the sauce by weight,
a combination of high omega three oil and pure omega three fatty acid, wherein the total omega three fatty acid present in the combination represents 1 percent to 30 percent of the sauce by weight,
medium chain triglyceride, wherein medium chain triglyceride represents 1 percent to 50 percent of the sauce by weight,
fagopyritrol, wherein fagopyritrol represents 0.25 percent to 20 percent of the sauce by weight,
lycopene, wherein the lycopene represents 0.25 percent to 20 percent of the sauce by weight, polyphenolic antioxidants of vegetable origin, wherein polyphenolic antioxidants represent 0.25 percent to 20 percent of the sauce by weight,
luteine, wherein the luteine represents 0.25 percent to 20 percent of the sauce by weight,
beta carotene, wherein the beta carotene represents 0.25 percent to 20 percent of the sauce by weight,
calcium stearate, wherein the calcium stearate represents 0.25 percent to 20 percent of the sauce by weight,
vitamin E, wherein the vitamin E represents 0.25 percent to 20 percent of the sauce by weight, and
bioflavonoid, wherein the bioflavonoid represents 0.25 percent to 20 percent of the sauce by weight.

12. Sauce of claim 1, further comprising at least one functional food and combinations thereof selected from a group consisting of high omega three oil; pure omega three fatty acid; a combination of high omega three oil and pure omega three fatty acid; medium chain triglyceride; fagopyritrol; lycopene; polyphenolic antioxidants of vegetable origin; luteine; beta carotene; calcium stearate; vitamin E; and bioflavonoid, wherein the sauce delivers at least 25% of the recommended daily intake of the functional food as reported by the United States Food and Drug Administration.

13. Sauce of claim 12, wherein the sauce delivers the recommended daily intake of the functional food as reported by the United States Food and Drug Administration.

14. Sauce of claim 1, further comprising at least one functional food and combinations thereof selected from a group consisting of high omega three oil; pure omega three fatty acid; a combination of high omega three oil and pure omega three fatty acid; medium chain triglyceride; fagopyritrol; lycopene; polyphenolic antioxidants of vegetable origin; luteine; beta carotene; calcium stearate; vitamin E; and bioflavonoid, wherein the sauce delivers at least 25% of the recommended daily intake of the functional food as reported by the European Commission.

15. Sauce of claim 14, wherein the sauce delivers the recommended daily intake of the functional food as reported by the European Commission.

16. Sauce of claim 1, further comprising at least one functional food and combinations thereof selected from a group consisting of high omega three oil; pure omega three fatty acid; a combination of high omega three oil and pure omega three fatty acid; medium chain triglyceride; fagopyritrol; lycopene; polyphenolic antioxidants of vegetable origin; luteine; beta carotene; calcium stearate; vitamin E; and bioflavonoid, wherein the sauce delivers at least 25% of the recommended daily intake of the functional food as reported by the FAO (Food and Agriculture Organization of the United Nations) in the Codex Alimentarius.

17. Sauce of claim 16, wherein the sauce delivers the recommended daily intake of the functional food as reported by the FAO (Food and Agriculture Organization of the United Nations) in the Codex Alimentarius.
